(19) United States
(12) Patent Application Publication
(10) Pub. No.: US 2013/0002953 A1
(43) Pub. Date: Jan. 3, 2013

(54) TRANSMISSION APPARATUS, RECEIVING APPARATUS, TRANSMISSION METHOD, AND RECEIVING METHOD

(75) Inventors: Hiroyuki NOGUCHI, Osaka (JP); Shinya MURAKAMI, Kyoto (JP)

(73) Assignee: PANASONIC CORPORATION, Osaka (JP)

(21) Appl. No.: 13/611,828

(22) Filed: Sep. 12, 2012

Related U.S. Application Data
(63) Continuation of application No. PCT/JP2011/001232, filed on Mar. 2, 2011.

(30) Foreign Application Priority Data
Mar. 25, 2010 (JP) 2010-070638

(51) Int. Cl. H04N 9/475

(52) U.S. Cl. 348/515; 348/E09.034

(57) ABSTRACT

A transmission apparatus according to the present invention includes: an audio input unit configured to obtain audio data of 32-bit precision and to add additional information to the audio data, to generate output audio data including the audio data of 32-bit precision and the additional information, the additional information indicating characteristics of the audio data obtained; and a video-audio synthesizing unit configured to: add packet type information to the output audio data generated by the audio input unit, to generate at least one audio sample packet; and multiplex the at least one audio sample packet into a horizontal blanking interval of video data, the packet type information indicating that the output audio data includes audio data of 32-bit precision.

### CROSS REFERENCE TO RELATED APPLICATION

This is a continuation application of PCT Patent Application No. PCT/JP2011/001232 filed on Mar. 2, 2011, designating the United States of America, which is based on and claims priority of Japanese Patent Application No. 2010-070638 filed on Mar. 25, 2010. The entire disclosures of the above-identified applications, including the specifications, drawings and claims are incorporated herein by reference in their entirety.

### FIELD

The present invention relates to transmission apparatuses and receiving apparatuses which transmit or receive video data and audio data, and particularly to a transmission apparatus and a transmission method of transmitting audio data in a horizontal blanking interval of video data and a receiving apparatus and a receiving method of receiving the audio data transmitted in the horizontal blanking interval of video data.

### BACKGROUND

In recent years, apparatuses and methods for transmitting and receiving audio data with high sound quality are under development.

For example, to meet the need for higher quality, an apparatus is under development which outputs audio data recorded on a blu-ray disc (BD) or the like and having a precision of maximum of 24 bits per sample, as analog data having a precision of maximum of 32 bits, by performing an arithmetic operation. For example, a technique for transmitting video data and audio data according to a high-definition multimedia interface (HDMI) standard is under development. Furthermore, Patent Literature (PTL) 1 discloses a data transmission apparatus and a data receiving apparatus by which audio data for a plurality of channels is transmitted and received. The data transmission apparatus disclosed in PTL 1 performs blocking processing so that data configured with n channel is allocated in blocks in which data of m (n≦m) channel can be stored. Moreover, the transmission apparatus disclosed in PTL 1 makes each block include identification information for identifying a channel to which no valid data is allocated, generates a transmission data stream that matches a predetermined transmission format, and transmits the data stream generated. This allows transmitting audio data for a plurality of channels. Therefore, it is possible to transmit and receive audio data with high sound quality.

### CITATION LIST

### Patent Literature

[PTL 1] Japanese Unexamined Patent Application Publication No. 2002-330133

### SUMMARY

### Technical Problem

However, the above conventional technique has the following problem.

The transmission standard on image and audio, such as HDMI, supports transmission in maximum precision of 24 bits. This means, for example, even when a source device in HDMI is capable of generating audio data of 32-bit precision, it is required to remove the lower 8 bits to transmit.

Furthermore, although PTL 1 discloses a technique to transmit and receive audio data for a plurality of channels, PTL 1 does not state the bit precision of the audio data.

The present invention has been conceived to solve the above problem, and has an object to provide a transmission apparatus, a receiving apparatus, a transmission method, and a receiving method which are capable of transmitting and receiving audio data of a higher precision without decreasing the bit precision of the audio data.

### Solution to Problem

In order to solve the above problem, the transmission apparatus according to an aspect of the present invention is a transmission apparatus which transmits video-audio data generated by multiplexing audio data into a horizontal blanking interval of video data. The transmission apparatus includes a synthesizing unit configured to: add packet type information to the output audio data, to generate at least one audio sample packet; and multiplex the generated at least one audio sample packet into the horizontal blanking interval of the video data, the output audio data including the audio data of 32-bit precision and the additional information, and the packet type information indicating that the output audio data includes audio data of 32-bit precision.

### Advantageous Effects

With the transmission apparatus, the receiving apparatus, the transmission method, and the receiving method, the audio data of a higher precision can be transmitted and received without decreasing the bit precision of the audio data.

### BRIEF DESCRIPTION OF DRAWINGS

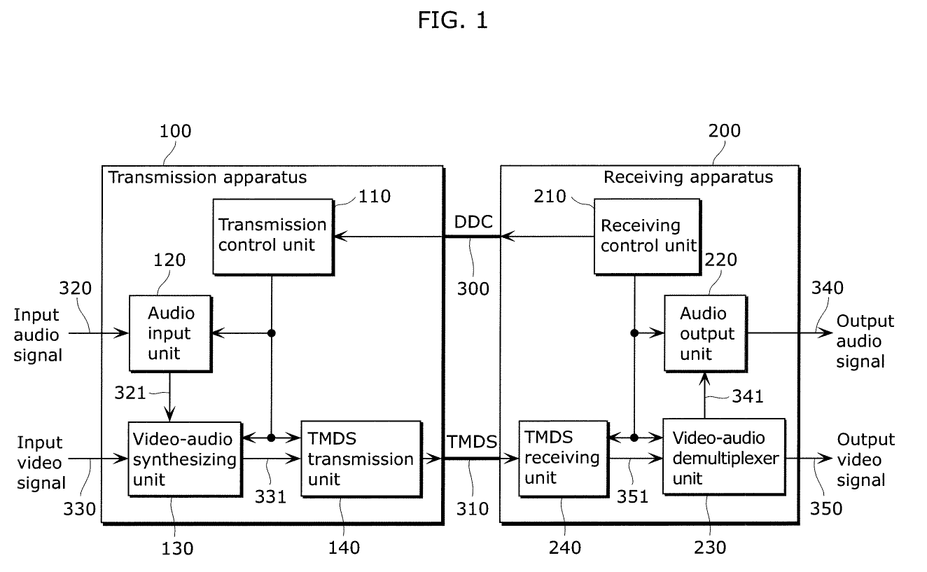

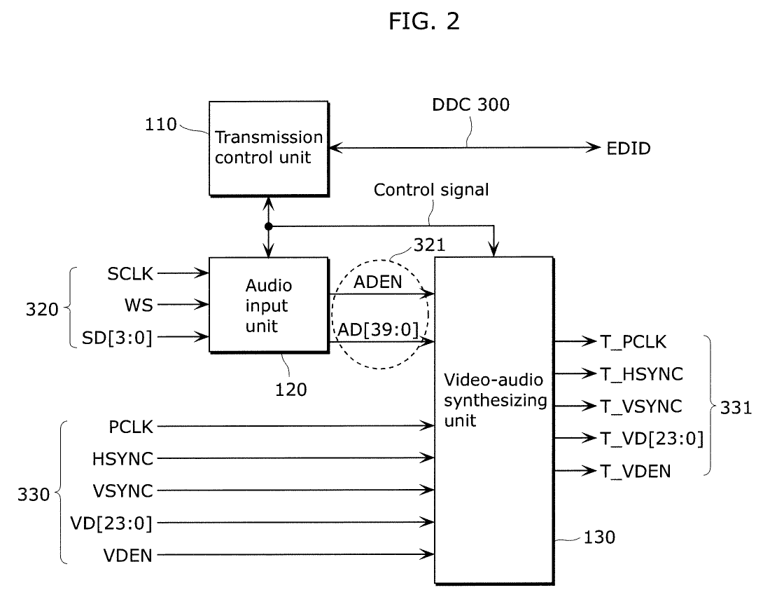

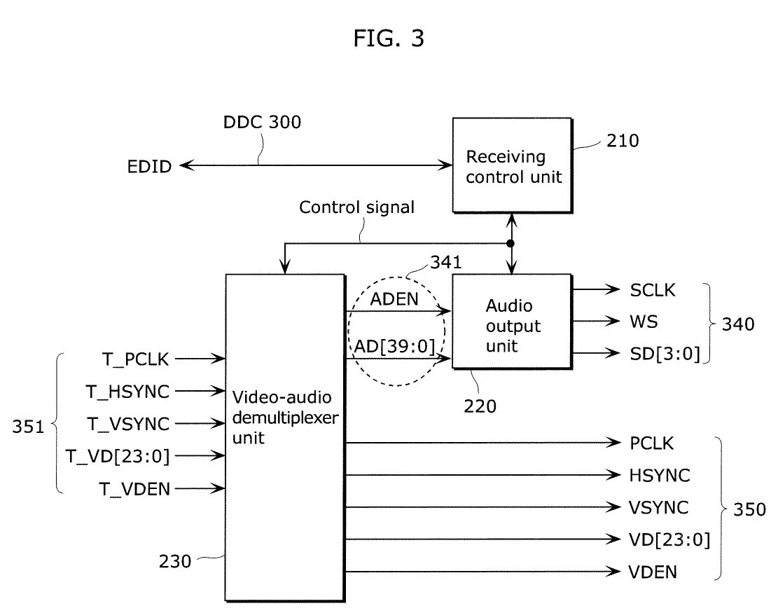

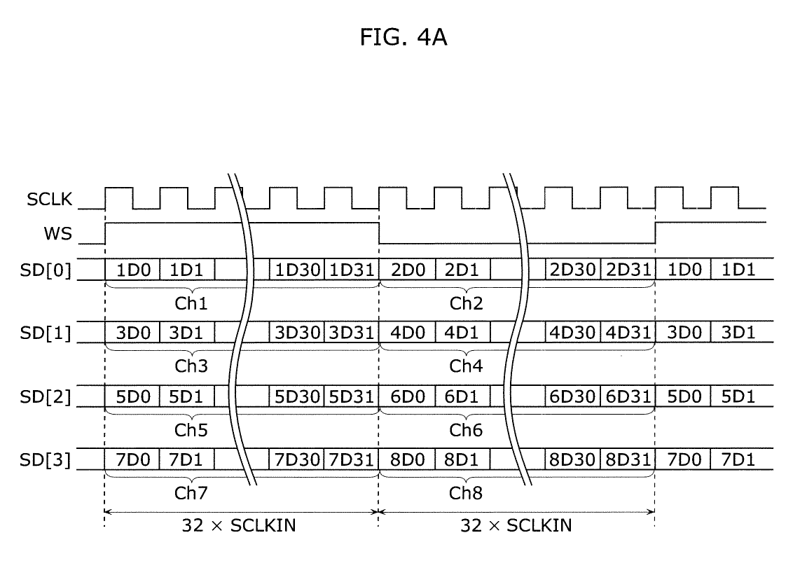

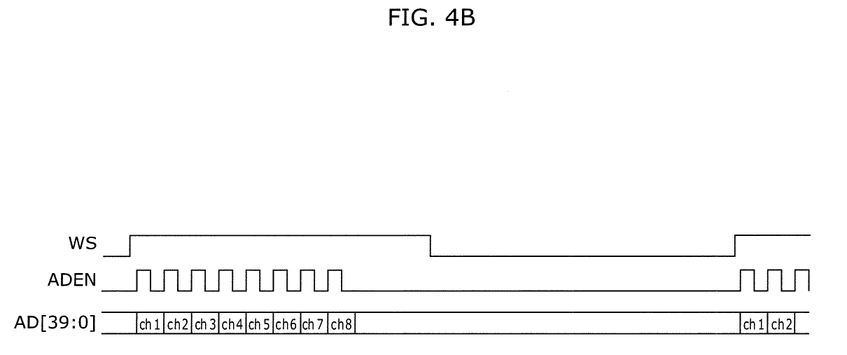

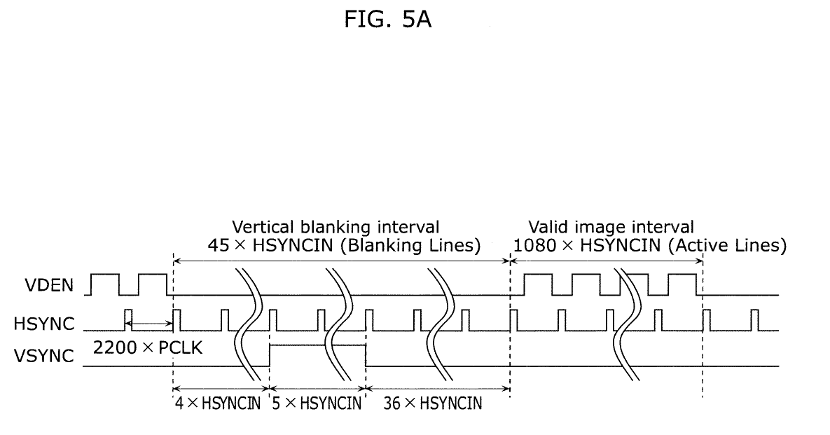

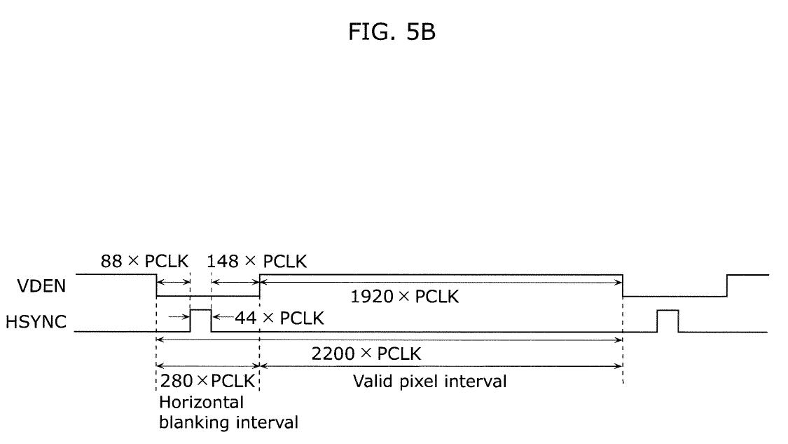

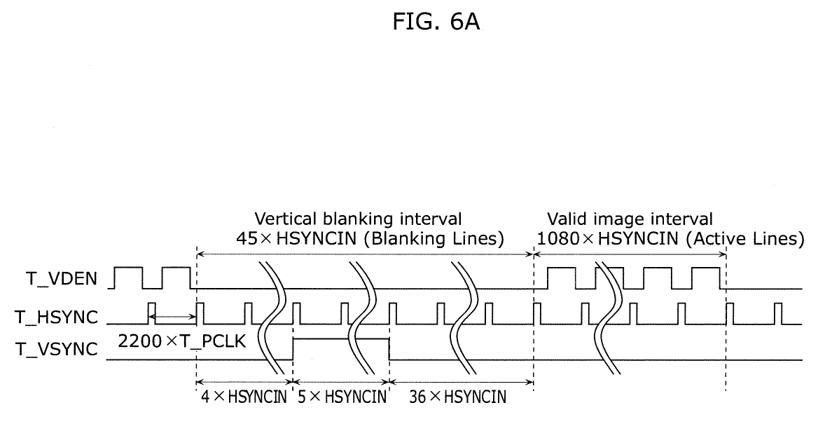

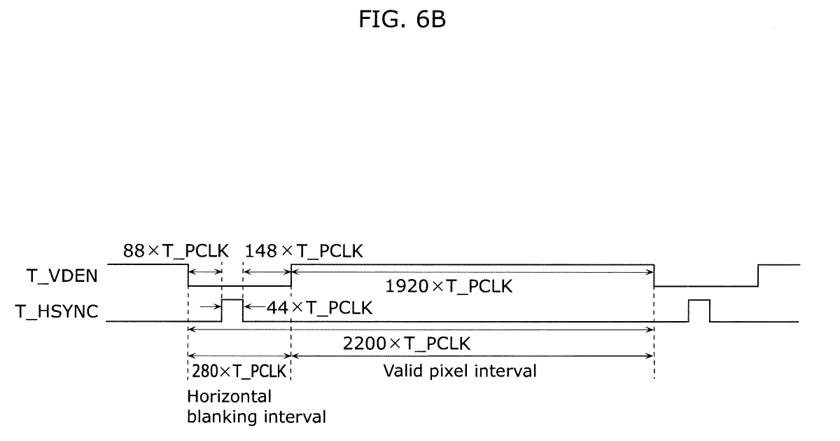

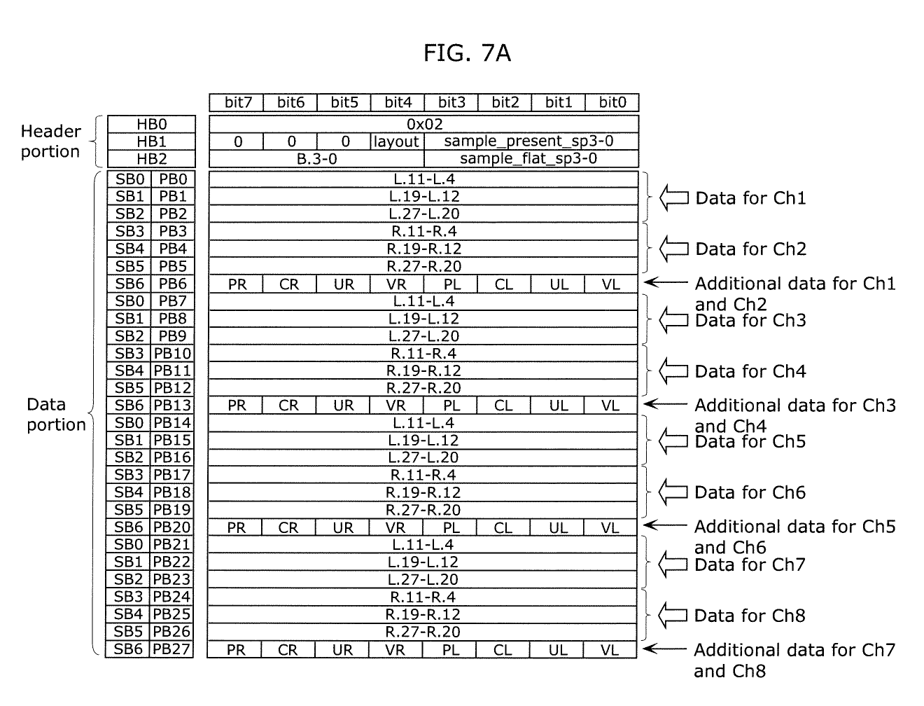

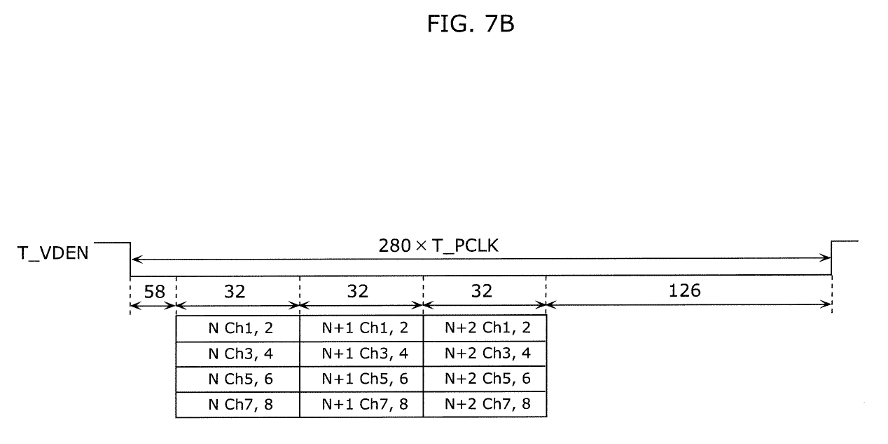

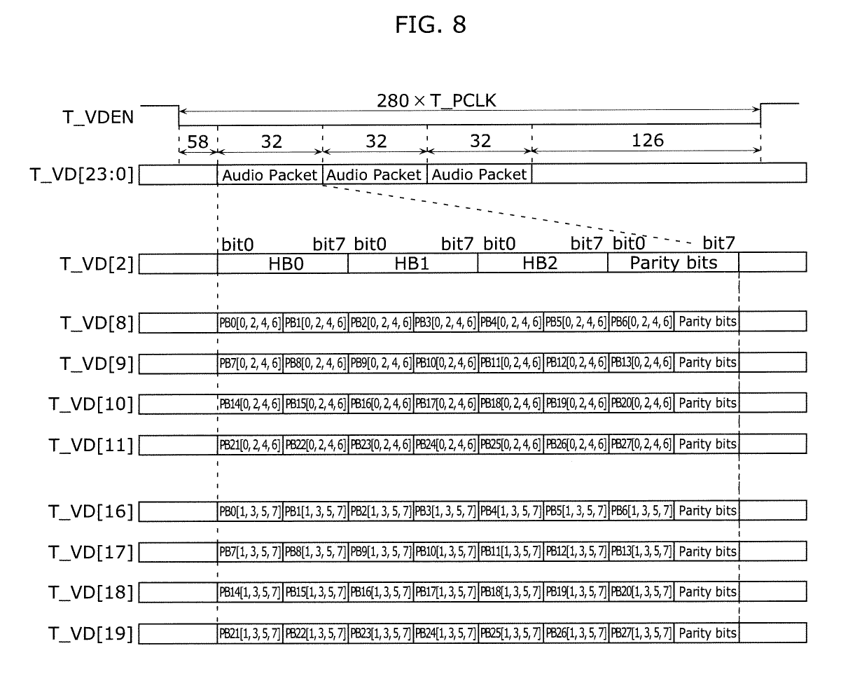

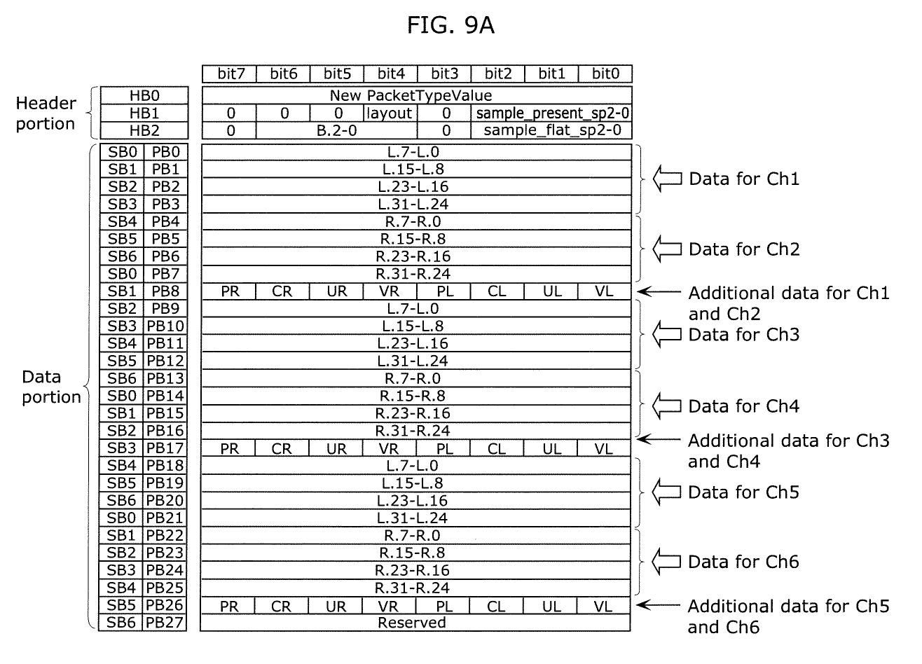

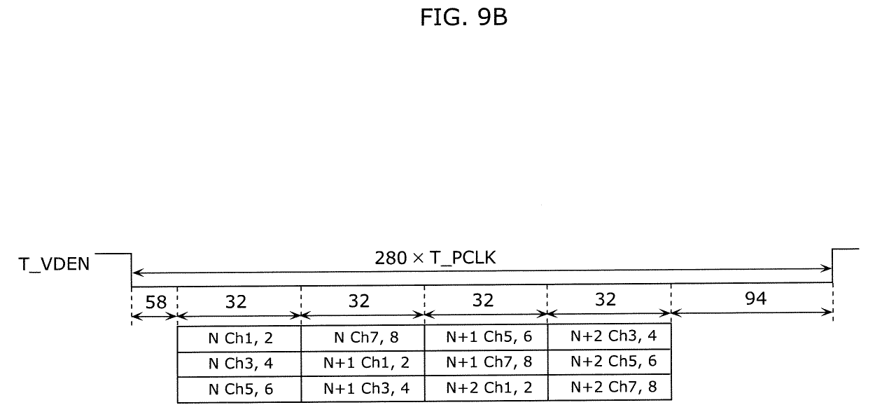

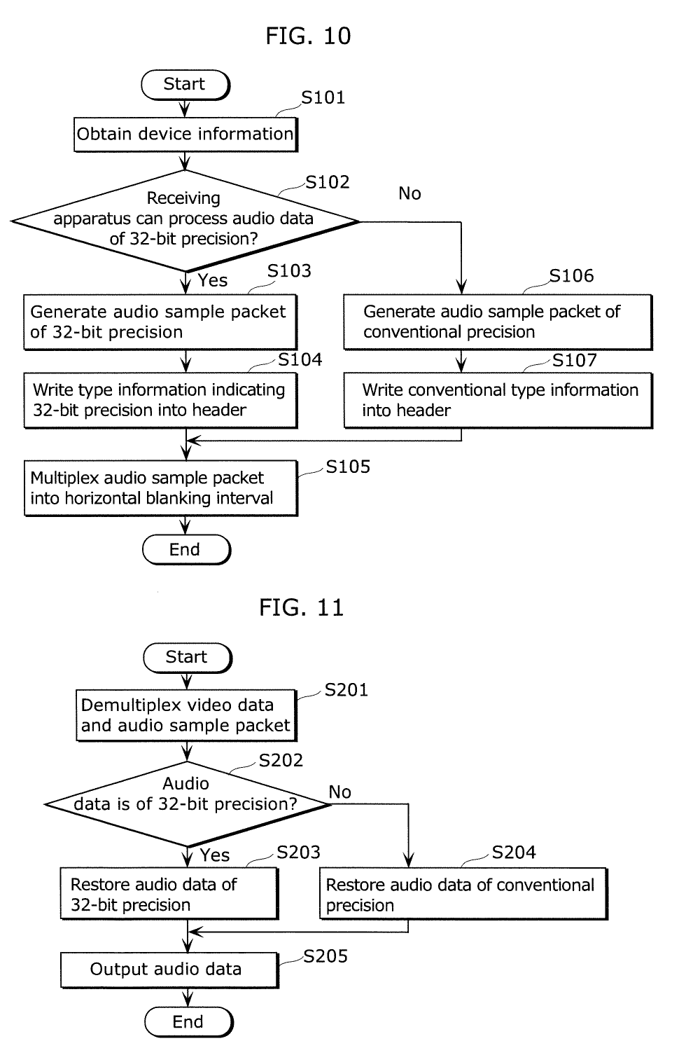

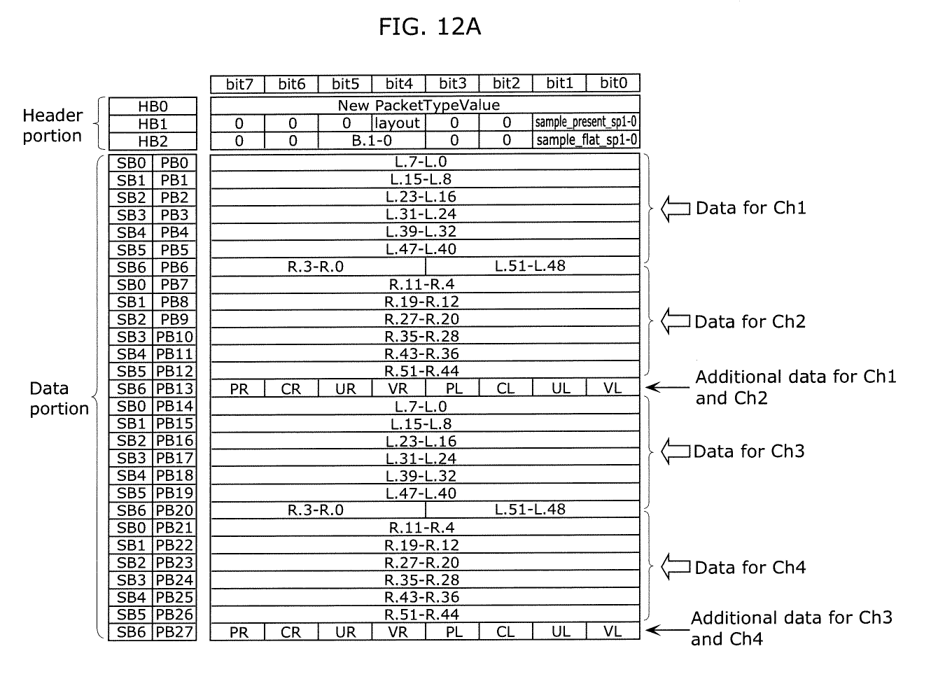

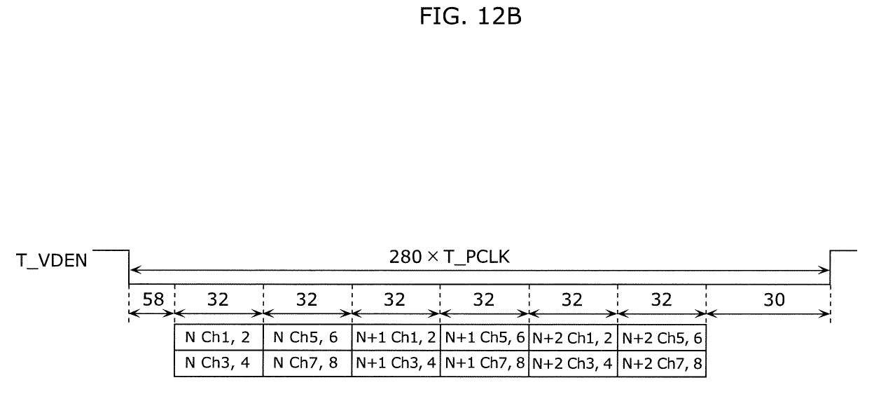

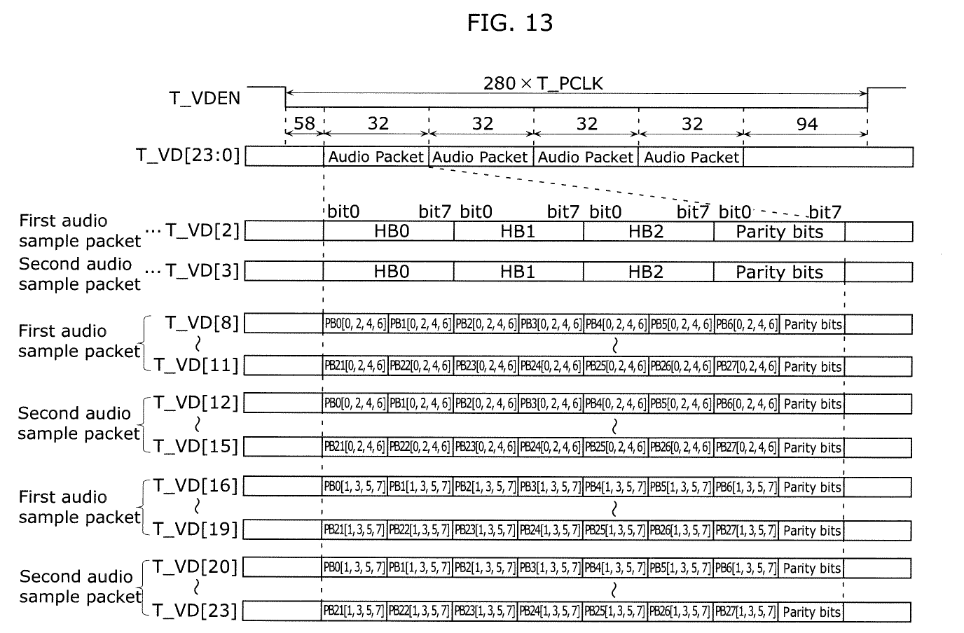

These and other objects, advantages and features of the invention will become apparent from the following description thereof taken in conjunction with the accompanying drawings that illustrate a specific embodiment of the present invention.

[FIG. 1]FIG. 1 shows a block diagram showing an example of a configuration of a transmission system according to an embodiment of the present invention.

[FIG. 2] FIG. 2 shows an example of data to be inputted into and outputted from a processing unit of a transmission apparatus according to the embodiment of the present invention.

[FIG. 3] FIG. 3 shows an example of data to be inputted into and outputted from the processing unit of a receiving apparatus according to the embodiment of the present invention.

[FIG. 4A] FIG. 4A shows a timing chart which shows an example of an input audio signal to be inputted into an audio input unit according to the embodiment of the present invention.

[FIG. 4B] FIG. 4B shows a timing chart which shows an example of an output audio signal to be outputted from the audio input unit according to the embodiment of the present invention.

[FIG. 5A] FIG. 5A shows a timing chart which shows an example of an input video signal to be inputted into a video-audio synthesizing unit according to the embodiment of the present invention.

[FIG. 5B] FIG. 5B shows a timing chart which shows a horizontal blanking interval of an input video signal to be inputted into the video-audio synthesizing unit according to the embodiment of the present invention.

[FIG. 6A] FIG. 6A shows a timing chart which shows an example of a video-audio signal to be outputted from the video-audio synthesizing unit according to the embodiment of the present invention.

[FIG. 6B] FIG. 6B shows a timing chart which shows a horizontal blanking interval of the video-audio signal to be outputted from the video-audio synthesizing unit according to the embodiment of the present invention.

[FIG. 7A] FIG. 7A shows an example of a format of conventional audio sample packets.

[FIG. 7B] FIG. 7B shows a timing chart which shows an example of output timing of the conventional audio sample packets.

[FIG. 8] FIG. 8 shows an example of allocation of audio sample packets.

[FIG. 9A] FIG. 9A shows an example of a format of audio sample packets according to the embodiment of the present invention.

[FIG. 9B] FIG. 9B shows a timing chart which shows an example of the output timing of the audio sample packets according to the embodiment of the present invention.

[FIG. 10] FIG. 10 shows a flowchart showing an example of an operation of the transmission apparatus according to the embodiment of the present invention.

[FIG. 11] FIG. 11 shows a flowchart showing an example of an operation of the receiving apparatus according to the embodiment of the present invention.

[FIG. 12A] FIG. 12A shows an example of a format of audio sample packets according to a modification example of the embodiment of the present invention.

[FIG. 12B] FIG. 12B shows a timing chart which shows output timing of the audio sample packets according to the modification example of the embodiment of the present invention.

[FIG. 13] FIG. 13 shows an example of allocation of the audio sample packets according to the modification example of the embodiment of the present invention.

### DESCRIPTION OF EMBODIMENT

The following describes the embodiment of the present invention based on the drawings.

The transmission apparatus according to the present invention is a transmission apparatus which transmits video-audio data generated by multiplexing audio data into a horizontal blanking interval of video data. The transmission apparatus includes a synthesizing unit configured to: add packet type information to the output audio data, to generate at least one audio sample packet; and multiplex the generated at least one audio sample packet into the horizontal blanking interval of the video data, the output audio data including the audio data of 32-bit precision and the additional information, and the packet type information indicating that the output audio data includes audio data of 32-bit precision.

Furthermore, a receiving apparatus according to the embodiment of the present invention is a receiving apparatus which receives from a transmission apparatus video-audio data generated by multiplexing at least one audio sample packet generated by packetizing audio data into a horizontal blanking interval of video data. The receiving apparatus includes a demultiplexer unit configured to: demultiplex from the video-audio data the at least one audio sample packet and the video data; and restore, from the demultiplexed at least one audio sample packet, input audio data including audio data of 32-bit precision and additional information indicating characteristics of the first audio data; wherein the demultiplexer unit is configured to: read packet type information included in a header of the demultiplexed at least one audio sample packet; and restore the input audio data of 32-bit precision when the read packet type information indicates that the at least one audio sample packet includes audio data of 32-bit precision.

A configuration of the transmission system including the transmission apparatus and the receiving apparatus according to the embodiment of the present invention is described first below.

FIG. 1 shows the block diagram showing an example of the configuration of the transmission system according to the embodiment of the present invention. The transmission system according to the embodiment of the present invention is a system in which video data and audio data are transmitted according to the HDMI standard, and specifically, the audio data is transmitted using a horizontal blanking interval of the video data.

As shown in FIG. 1, the transmission system includes a transmission apparatus 100 and a receiving apparatus 200. The transmission apparatus 100 and the receiving apparatus 200 are connected via a display data channel (DDC) signal line 300 and a transition minimized differential signaling (TMDS) signal line 310.

As shown in FIG. 1, the transmission apparatus 100 includes a transmission control unit 110, an audio input unit 120, a video-audio synthesizing unit 130, and a TMDS transmission unit 140.

The transmission control unit 110 obtains device information indicating whether or not the receiving apparatus 200 is capable of processing audio data of 32-bit precision. Then, based on the obtained device information, the transmission control unit 110 controls processing of the audio input unit 120, the video-audio synthesizing unit 130, and the TMDS transmission unit 140.

Specifically, the transmission control unit 110 obtains extended display identification data (EDID) which is the device information of the receiving apparatus 200, via the DDC signal line 300. EDID includes information indicating audio data of how many bits precision the receiving apparatus 200 is capable of processing. For example, EDID includes information indicating whether or not the receiving apparatus 200 is capable of processing audio data of 32-bit precision.

Accordingly, the transmission control unit 110 determines whether or not the receiving apparatus 200 has a function to receive the audio data of 32-bit precision based on the EDID that is the device information, and optimally controls the audio input unit 120, the video-audio synthesizing unit 130, and the TMDS transmission unit 140 based on the determination result. Specifically, the transmission control unit 110 determines a bit precision and a sampling frequency of the audio data to be transmitted to the receiving apparatus 200.

The audio input unit 120 obtains audio data of 32-bit precision and adds additional information for the obtained audio data to the audio data, to generate output audio data including the audio data of 32-bit precision and the additional information. The generated output audio data is outputted to the video-audio synthesizing unit 130.

Specifically, as shown in FIG. 2, the audio input unit 120 obtains an input audio signal 320 including SCLK, WS, and SD [3:0], and outputs an output audio signal 321 including ADEN and AD [39:0].

SCLK is a signal indicating a clock of an audio signal. WS is a signal indicating a sampling frequency. SD [3:0] is a signal indicating input audio data. ADEN is a signal indicating whether the audio data is valid or invalid. AD [39:0] is a signal indicating output audio data which is audio data added with additional information.

The audio input unit 120 obtains audio data of 32-bit precision for n channel, as the input audio signal 320. Here, n is between 1 and 8 inclusive. In other words, the audio input unit 120 can obtain audio data of 32 bits×8 ch in one sampling period (one cycle of WS).

Then, the audio input unit 120 adds, additional information of 8 bits to audio data of 32 bits for 1 channel, in one sampling period, to generate output audio data of 40 bits for one channel. It is to be noted that the additional information here is information required for reproducing the audio data at the receiving apparatus 200, such as preamble information, parity information, sampling clock information, and user data bit information.

In the same manner, the audio input unit 120 generates output audio data for eight channels, and outputs the generated output audio data as an output audio signal 321 to the video-audio synthesizing unit 130. Specific examples of the input audio signal 320 and the output audio signal 321 are described later.

The video-audio synthesizing unit 130 adds packet type information to the output audio data, to generate at least one audio sample packet. The packet type information indicates that the output audio data includes audio data of 32-bit precision. The video-audio synthesizing unit 130 then multiplexes the generated at least one audio sample packet into the horizontal blanking interval of the video data.

For example, the video-audio synthesizing unit 130 generates at least one audio sample packet by packetizing the output audio data and outputs the generated at least one audio sample packet in the horizontal blanking interval of the video data, to multiplex the video data and the at least one audio sample packet. For example, the video-audio synthesizing unit 130 generates the at least one audio sample packet by packetizing the output audio data for n channel into output audio data for m channel, and outputs the generated at least one audio sample packet in the horizontal blanking interval of the video data. Here, m is between 1 and 6 inclusive.

Moreover, the video-audio synthesizing unit 130 writes into a header of the at least one audio sample packet the packet type information indicating that the at least one audio sample packet includes the audio data of 32-bit precision.

The video-audio synthesizing unit 130 multiplexes the at least one audio sample packet into the horizontal blanking interval of the video data, in the above manner. A specific example of a configuration of the at least one audio sample packet is described later.

It is to be noted that an input video signal 330 is inputted into the video-audio synthesizing unit 130. As shown in FIG. 2, the input video signal 330 includes PCLK, HSYNC, VSYNC, VD [23:0], and VDEN.

PCLK is a signal indicating a pixel clock of the video data. HSYNC is a horizontal synchronization signal of the video data. VSYNC is a vertical synchronization signal of the video data. VD [23:0] is a signal indicating the video data. VDEN is a signal indicating whether the video data is valid or invalid.

The video-audio synthesizing unit 130 outputs a video-audio signal 331 generated by multiplexing. As shown in FIG. 2, the video-audio signal 331 includes T_PCLK, T_HSYNC, T_VSYNC, T_VD [23:0], and T_VDEN.

T_PCLK is a signal indicating a pixel clock of the video data. T_HSYNC is a horizontal synchronization signal of the video data. T_VSYNC is a vertical synchronization signal of the video data. T_VD [23:0] is a signal indicating the video data. T_VDEN is a signal indicating whether the video data is valid or invalid. It is to be noted that, as described above, T_VD [23:0] serves as a signal indicating the output audio data instead of the video data in a horizontal blanking interval of the video data.

The TMDS transmission unit 140 converts the video-audio signal 331 generated by the video-audio synthesizing unit 130 into a differential analog signal, and transmits the differential analog signal obtained by the conversion to the receiving apparatus 200 via the TMDS signal line 310. Specifically, the TMDS transmission unit 140 converts data of 8 bits into data of 10 bits, by adding 2 bits to the video-audio signal 331 by encoding the video-audio signal 331 for every eight bits. Here, the TMDS transmission unit 140 adds a bit so that the same number of 0 and 1 are included in the data after the conversion. Then, the TMDS signal line 310 converts the video and audio signal 331 after the addition of the bit into serial data and then into a differential analog signal, to transmit the video-audio signal 331 after the conversion.

As shown in FIG. 1, the receiving apparatus 200 includes a receiving control unit 210, an audio output unit 220, a video-audio demultiplexer unit 230, and a TMDS receiving unit 240.

The receiving control unit 210 obtains packet identification information read from the header of the at least one audio sample packet by the video-audio demultiplexer unit 230, and determines whether or not the obtained packet identification information indicates that the at least one audio sample packet includes the audio data of 32-bit precision. Then, the receiving control unit 210 controls the operation of the audio output unit 220 and the video-audio demultiplexer unit 230 based on the determination result.

The audio output unit 220 removes the additional information from the input audio data restored by the video-audio demultiplexer unit 230, to output the audio data of 32-bit precision. Specifically, as shown in FIG. 3, the audio output unit 220 obtains an input audio signal 341 including ADEN and AD [39:0], and outputs an output audio signal 340 including SCLK, WS, and SD [3:0]. It is to be noted that the input audio signal 341 is the same as the output audio signal 321 outputted by the audio input unit 120 of the transmission apparatus 100, and the output audio signal 340 is the same as the input audio signal 320 obtained by the audio input unit 120 of the transmission apparatus 100.

The video-audio demultiplexer unit 230 demultiplexes from the video-audio data the at least one audio sample packet and the video data, and restores from the demultiplexed at least one audio sample packet the input audio data including the audio data of 32-bit precision and the additional information. For example, the video-audio demultiplexer unit 230: demultiplexes from the video-audio data the at least one audio sample packet and the video data; and restores from the demultiplexed at least one audio sample packet the input audio data for n channel. The at least one audio sample packet is generated by packetizing the audio data for m channel, m is between 1 and 6 inclusive, and n is between 1 and 8 inclusive.

Specifically, as shown in FIG. 3, the video-audio demultiplexer unit 230 obtains a video-audio signal 351 generated by the TMDS receiving unit 240. The video-audio signal 351 includes T_PCLK, T_HSYNC, T_VSYNC, T_VD [23:0], and T_VDEN. The video-audio signal 351 is the same as the video-audio signal 331 outputted by the video-audio synthesizing unit 130 of the transmission apparatus 100.

Furthermore, the video-audio demultiplexer unit 230 reads the at least one audio sample packet from the horizontal blanking interval of the video-audio signal, to demultiplex the video-audio signal 351 into the at least one audio sample packet and an output video signal 350. The output video signal 350 includes a PCLK, HSYNC, VSYNC, VD [23:0], and VDEN. It is to be noted that the output video signal 350 is the same as the input video signal 330 obtained by the video-audio synthesizing unit 130 of the transmission apparatus 100.

The TMDS receiving unit 240 receives the differential analog signal transmitted from the transmission apparatus 100 via the TMDS signal line 310, and converts the received differential analog signal into the video-audio signal 351. Specifically, the TMDS receiving unit 240 performs processing reverse to the processing performed by the TMDS transmission unit 140. In other words, the TMDS receiving unit 240 converts the received differential analog signal into parallel data and TMDS decodes the parallel data obtained by the conversion for every 10 bits, thereby removing 2 bits and restoring the video-audio signal 351. Accordingly, the video-audio signal 351 is the same signal as the video-audio signal 331 generated by the video-audio synthesizing unit 130 of the transmission apparatus 100.

The following describes the input audio signal 320 to be inputted into the audio input unit 120 and the output audio signal 321 to be outputted from the audio input unit 120, with reference to FIG. 4A and FIG. 4B. FIG. 4A shows a timing chart which shows an example of the input audio signal 320 to be inputted into the audio input unit 120 according to the embodiment of the present invention. Furthermore, FIG. 4B shows a timing chart which shows an example of the output audio signal 321 to be outputted from the audio input unit 120 according to the embodiment of the present invention.

As shown in FIG. 4A, SCLK, WS, and SD [0] to SD [3] (SD [3:0] in FIG. 2) are inputted into the audio input unit 120 (three-wire system). It is to be noted that SD [3:0] represents four data lines, namely SD [0] to SD [3], and data of 4 bits per one sampling clock are parallely inputted to the audio input unit 120.

SCLK is a clock synchronized with SD [3:0] indicating the audio data. WS regards 64 clocks of SCLK as one cycle, and corresponds to a sampling clock of the audio data.

SD[0] to SD[3] are signals indicating the audio data, are synchronized with the clock of SCLK, and are capable of transmitting data of 32 bits×8 ch per one cycle of WS. As shown in FIG. 4A, SD[0] is an audio signal indicating the audio data of 32 bits for a first channel (Ch1) and the audio data of 32 bits for a second channel (Ch2). It is to be noted that, in FIG. 4A, “1D0” indicates a 0th bit for the first channel and “2D31” indicates a 31st bit for the second channel. In other words, “pDq” indicates a q-th bit for a p-th channel. It is to be noted that the bit is counted from number 0 in the present embodiment.

In the same manner, SD [1] is an audio signal indicating the audio data of 32 bits for a third channel (Ch3) and the audio data of 32 bits for a fourth channel (Ch4). SD [2] is an audio signal indicating the audio data of 32 bits for a fifth channel (Ch5) and the audio data of 32 bits for a sixth channel (Ch6). SD [3] is an audio signal indicating the audio data of 32 bits for a seventh channel (Ch7) and the audio data of 32 bits for an eighth channel (Ch8).

The audio input unit 120 converts the input audio signal 320 as shown in FIG. 4A into the output audio signal 321 as shown in FIG. 4B, and outputs the output audio signal 321. Specifically, the audio input unit 120 adds, during one sampling period, additional information of 8 bits to the audio data having 32 bits, to generate output audio data of 40 bits.

As shown in FIG. 4B, ADEN is a signal for identifying whether the output audio data is valid or invalid. AD [39:0] is a signal indicating output audio data. AD [39:0] indicates output audio data of 40-bit precision for 8 channels, including the audio data of 32-bit precision for 8 channels and the additional information of 8 bits added to each of the audio data. AD [39:0] represents forty data lines, namely AD [0] to AD [39], and the audio input unit 120 can parallely output data of 40 bits per one sampling clock.

As shown in FIG. 4B, the audio input unit 120 can parallely output 40 bits. Accordingly, the output audio data for 8 ch can be multiplexed per one cycle of WS.

It is to be noted that SCLK, WS, and SD[3:0] shown in FIG. 4A are the same as the output audio signal 340 to be outputted from the audio output unit 220 of the receiving apparatus 200 shown in FIG. 3. Furthermore, ADEN and AD[39:0] shown in FIG. 4B are the same as the input audio signal 341 to be inputted into the audio output unit 220 of the receiving apparatus 200 shown in FIG. 3.

The following describes the input video signal 330 to be inputted to the video-audio synthesizing unit 130, with reference to FIG. 5A and FIG. 5B. FIG. 5A shows a timing chart which shows an example of the input video signal 330 to be inputted into the video-audio synthesizing unit 130 according to the embodiment of the present invention. Furthermore, FIG. 5B shows a timing chart which shows the horizontal blanking interval of the input video signal 330 shown in FIG. 5A.

It is to be noted that the present embodiment describes, as an example, a case where the input video signal 330 is a video signal complying with a format called 1080 p in which a cycle per frame is 60 Hz and valid video data per frame is 1080 vertical lines and 1920 horizontal lines.

HSYNC shown in FIG. 5A is for 2200 cycles of PCLK synchronized with the image data, and is a horizontal synchronization signal representing a cycle for one line including valid data and blanking data. VSYNC is a vertical synchronization signal representing a cycle for 1125 lines including valid lines and blanking lines.

VDEN is a signal indicating whether or not the image data is valid data, and, in the example shown in FIG. 5A and FIG. 5B, indicates that the image data is valid between a 37th cycle to a 1116th cycle of HSYNC starting from a fall of VSYNC and between a 149th cycle to a 2068th cycle of PCLK starting from a fall of HSYNC.

In other words, as shown in FIG. 5A, the input video signal 330 includes a vertical blanking interval for 45 lines and valid image interval for 1080 lines, and the video data is included in the valid image interval. More specifically, as shown in FIG. 5B, a horizontal blanking interval for 280 pixel clocks and valid image interval for 1920 pixel clocks are also in the valid image interval, and the valid image interval includes the video data.

It is to be noted that VDEN, HSYNC, and VSYNC shown in FIG. 5A are the same as the output video signal 350 outputted from the video-audio demultiplexer unit 230 of the receiving apparatus 200 shown in FIG. 3.

Next, the video-audio signal 331 outputted from the video-audio synthesizing unit 130 is described using FIG. 6A and FIG. 6B. It is to be noted that FIG. 6A shows a timing chart which shows an example of the video-audio signals 331 to be outputted from the video-audio synthesizing unit 130 according to the embodiment of the present invention. Furthermore, FIG. 6B shows a timing chart which shows a horizontal blanking interval of the video-audio signal 331 shown in FIG. 6A.

The transmission apparatus 100 according to the present embodiment multiplexes the audio data into the horizontal blanking interval of the video data. In other words, the video-audio synthesizing unit 130 outputs to the TMDS transmission unit 140 the inputted video data without performing any processing.

Accordingly, as shown in FIG. 6A and FIG. 6B, T_PCLK, T_HSYNC, T_VSYNC, and T_VDEN are outputted at the same timing as PCLK, HSYNC, VSYNC, and VDEN shown in FIG. 5A and FIG. 5B, respectively. The video-audio synthesizing unit 130 outputs the audio data instead of the video data using the 24 data lines (T_VD [23:0]), in the horizontal blanking interval shown in FIG. 6B.

It is to be noted that the T_VDEN, T_HSYNC, and T_VSYNC shown in FIG. 6A are the same as the video-audio signals 351 to be inputted to the video-audio demultiplexer unit 230 of the receiving apparatus 200 shown in FIG. 3.

Here, a conventional method of multiplexing the audio data into the horizontal blanking interval is described using FIG. 7A and FIG. 7B.

FIG. 7A shows an example of the format of the conventional audio sample packets. The audio sample packet includes a header portion and a data portion.

As shown in FIG. 7A, the header portion is configured with data of 3 bytes, namely HB0, HB1, and HB2. It is to be noted that “HBn” represents n-th header. In the conventional audio sample packet, “0×02” (“2” in decimal number) is written in “HB0”. “0×02” is a value indicating that the data of the audio sample packet is configured as shown in FIG. 7A. Specifically, “0×02” indicates that audio data of 24-bit precision for maximum of 8 channels is included in the data portion of the audio sample packet.

The data portion is configures with data of 28 bytes, namely PB0 to PB27. It is to be noted that “PBn” represents n-th data in a packet. Furthermore, “SBn” represents n-th data in a sub-packet. In other words, in the example shown in FIG. 7A, the data of 28 bytes is configured with four sub-packets each of which is 7 bytes.

As shown in FIG. 7A, PB0 to PB6 include audio data of 24-bit precision for the first channel, audio data of 24-bit precision for the second channel, and additional data for the audio data for each of the first channel and the second channel. Specifically, PB0 to PB2 include data of 24 bits for the first channel (L.27 to L.4), and PB3 to PB5 include data of 24 bits for the second channel (R.27 to R.4). PB6 includes PL, CL, UL, and VL which are the additional information for the first channel, and PR, CR, UR, and VR which are the additional information for the second channel.

In the same manner, PB7 to PB13 include the audio data and the additional information for the third channel and the fourth channel, PB14 to PB20 include the audio data and the additional information for the fifth channel and the sixth channel, and PB21 to PB27 include the audio data and the additional information for the seventh channel and the eighth channel.

It is to be noted that each of PL and PR is a ParityBit (Pbit) for each channel, in other words, an example of an error-detecting code used for error correction. Specifically, PL included in PB6 is a ParityBit for the data of 24 bits for the first channel, CL, UL, and VL. PR included in PB6 is a ParityBit for the data of 24 bits for the second channel, CR, UR, and VR.

Each of CL and CR is a ChannelStatusBit (Cbit) which indicates data attribute of the audio sample packet. Specifically, each of CL and CR indicates data attribute such as whether or not the audio sample packet is linear pulse code modulation (LPCM) sampling frequency, and the bit precision, by regarding Cbits for 192 channels as one set.

Each of UL and UR is a UserDataBit (Ubit). In the three line system as in the present invention, Ubit is 0.

Each of VL and VR is a ValidBit (Vbit) which indicates whether or not the data for each channel is valid. When the data is valid, Vbit is 0.

The video-audio synthesizing unit 130 multiplexes the at least one audio sample packet having the data structure for maximum of 8 channels as shown in FIG. 7A in the horizontal blanking interval (interval during the 280 pixel clocks) of the video data, as shown in FIG. 7B. It is to be noted that the horizontal blanking interval is an interval during T_VDEN is in a low level.

As shown in FIG. 7B, the video-audio synthesizing unit 130 does not output the audio data in the interval during the first 58 pixel clocks in the horizontal blanking interval. The video-audio synthesizing unit 130 multiplexes the at least one audio sample packet from a 59th clock in the pixel clock cycle of the horizontal blanking interval. Specifically, the video-audio synthesizing unit 130 multiplexes the at least one audio sample packet based on an allocation method as shown in FIG. 8.

FIG. 8 shows an example of allocation of audio sample packets.

T_VD[23:0] represents 24 data lines (T_VD[0] to T_VD[23]), and the video-audio synthesizing unit 130 can parallely output data of 24 bits per one sampling clock. For example, when outputting the video data, that is in a valid pixel interval (interval during T_VDEN is in a high level), the video-audio synthesizing unit 130 can parallely output RGB data on an 8-bit basis. FIG. 8 describes a case where the video-audio synthesizing unit 130 outputs the audio data, in other words, when the video-audio synthesizing unit 130 multiplexes the at least one audio sample packet into the horizontal blanking interval.

In T_VD[2], the video-audio synthesizing unit 130 transmits data of 32 bits including (i) HB0, HB1, and HB2, each of which is 8 bits, and (ii) ParityBits of 8 bits for use in an error correction for HB0, HB1, and HB2, in series starting from the least significant bit (LSB).

In T_VD [8], PB0 to PB6 are transmitted in the following order: PB0 [0], PB0 [2], PB0 [4], and PB0 [6]. In other words, in T_VD [8], even-number bits of PB0 to PB6 are transmitted. Moreover, in T_VD [8], ParityBits for use in the error correction for the even-number bits of PB0 to PB6 are transmitted in the end of the even-number bits of PB0 to PB6. It is to be noted that PB0 [0] represents the 0th bit of PB0, and PB0 [2] represents the second bit of PB0.

In T_VD [16], PB0 to PB6 are transmitted in the following order: PB0 [1], PB0 [3], PB0 [5], and PB0 [7]. In other words, in T_VD [16], odd-number bits of PB0 to PB6 are transmitted.

Moreover, in T_VD [16], ParityBits for use in the error correction for the odd-number bits of PB0 to PB6 are transmitted in the end of the odd-number bits of PB0 to PB6.

In the same manner, in T_VD [9] and T_VD [17], PB7 to PB13 and the paritybits are transmitted. In T_VD [10] and T_VD [18], PB14 to PB20 and the paritybits are transmitted. In T_VD [11] and T_VD [19], PB21 to PB27 and the paritybits are transmitted.

In the above manner, the conventional audio sample packets shown in FIG. 7A is outputted in the horizontal blanking interval of the video data.

In the present embodiment, the audio data included in the at least one audio sample packet is of 32-bit precision. Accordingly, as shown in FIG. 9A, the video-audio synthesizing unit 130 changes the format of the at least one audio sample packet. More specifically, the video-audio synthesizing unit 130 writes, into the header of the at least one audio sample packet, the packet type information indicating that the at least one audio sample packet includes the audio data of 32-bit precision.

In the present embodiment, the frame of the data (size of packet) of the at least one audio sample packet is the same as the conventional audio sample packet, even when the audio data is of 32-bit precision. In other words, as shown in FIG. 9A, the at least one audio sample packet according to the present embodiment is configured with the header portion configured with HB0 to HB2 and the data portion configured with PB0 to PB27, in the same manner as in the conventional technique. The at least one audio sample packet according to the present embodiment differs from the conventional technique in the information to be written into the header portion and in the allocation method of the audio data to be written into the data portion.

Specifically, the video-audio synthesizing unit 130 writes into HB0 a new PacketTypeValue indicating that the data is of a new packet type. More specifically, the video-audio synthesizing unit 130 writes, for example, “0×0B” (“11” in decimal number) as the new HB0, instead of “0×02” (“2” in decimal number) written into HB0 in the conventional technique. “0×0B” is an example of the new PacketTypeValue, and indicates that the data portion of the at least one audio sample packet includes the audio data of 32-bit precision for 6 channels.

Furthermore, as shown in FIG. 9A, PB0 to PB8 include audio data of 32-bit precision for the first channel, audio data of 32-bit precision for the second channel, and additional data for the audio data for each of the first channel and the second channel. Specifically, PB0 to PB3 include data of 32 bits for the first channel (L.0 to L.31), and PB4 to PB7 include data of 32 bits for the second channel (R.0 to R.31). PB8 includes PL, CL, UL, and VL which are the additional information for the first channel, and PR, CR, UR, and VR which are the additional information for the second channel.

In the same manner, PB9 to PB17 include the audio data and the additional information for the third channel and the fourth channel, and PB18 to PB26 include the audio data and the additional information for the fifth channel and the sixth channel. It is to be noted that PB27 is vacant and may include other information.

The video-audio synthesizing unit 130 multiplexes the at least one audio sample packet, which has the data for maximum of 6 channels as shown in FIG. 9A, into the horizontal blanking interval (interval during the 280 pixel clocks) of the video data, as shown in FIG. 9B.

It is to be noted that when the audio data of 32-bit precision for 8 channels is inputted, the video-audio synthesizing unit 130 can include into one audio sample packet the audio data of 32-bit precision for only 6 channels, as shown in FIG. 9A. Therefore, as shown in FIG. 9B, the video-audio synthesizing unit 130 packetizes the audio signals for 8 channels of 3 samples, to generate four of the at least one audio sample packet.

In other words, the video-audio synthesizing unit 130 generates a first audio sample packet by packetizing the output audio data for the first channel through the sixth channel of a first sample (sample N). Furthermore, the video-audio synthesizing unit 130 generates a second audio sample packet by packetizing the output audio data for the seventh channel and the eighth channel of the first sample and for the first channel through the fourth channel of a second sample (sample N+1). Furthermore, the video-audio synthesizing unit 130 generates a third audio sample packet by packetizing the output audio data for the fifth channel through the eighth channel of the second sample and for the first channel and the second channel of a third sample (sample N+2). The video-audio synthesizing unit 130 generates a fourth audio sample packet by packetizing the output audio data for the third channel through the eighth channel of the third sample.

The video-audio synthesizing unit 130 multiplexes the first audio sample packet to fourth audio sample packet generated in the above manner for every 32 clocks starting from the 59th clock in the pixel clock cycle of the horizontal blanking interval. It is to be noted that the audio sample packets shown in FIG. 9A can be multiplexed into the horizontal blanking interval of the video data by the allocation method shown in FIG. 8, in the same manner as in the case where the audio data is of 24-bit precision.

It is to be noted that, in the receiving apparatus 200, the video-audio demultiplexer unit 230 restores from the first audio sample packet the input audio data for the first channel through the sixth channel of the first sample (sample N). Furthermore, the video-audio demultiplexer unit 230 restores from the second audio sample packet the input audio data for the seventh channel and the eighth channel of the first sample and for the first channel through the fourth channel of the second sample (sample N+1). Furthermore, the video-audio demultiplexer unit 230 restores from the third audio sample packet the input audio data for the fifth channel through the eighth channel of the second sample and for the first channel and the second channel of the third sample (sample N+2). The video-audio demultiplexer unit 230 restores from the fourth audio sample packet the input audio data for the third channel through the eighth channel of the third sample.

Here, an operation of the transmission apparatus 100 and the receiving apparatus 200 according to the embodiment of the present invention is described.

FIG. 10 shows a flowchart showing an example of the operation of the transmission apparatus 100 according to the embodiment of the present invention.

First, the transmission control unit 110 obtains EDID, as the device information, from the receiving apparatus 200 via the DDC signal line 300 (S101). Then, the transmission control unit 110 determines whether or not the obtained device information indicates that the receiving apparatus 200 is capable of processing the audio data of 32-bit precision (S102).

When the receiving apparatus 200 is capable of processing the audio data of 32-bit precision (Yes in S102), the video-audio synthesizing unit 130 generates at least one audio sample packet including the audio data of 32-bit precision (S103). The video-audio synthesizing unit 130 writes, into the header portion of the at least one audio sample packet, the packet type information (“0×0B”, for example) indicating that the at least one audio sample packet includes the audio data of 32-bit precision (S104).

For example, the audio input unit 120 first adds additional information to the inputted audio data of 32-bit precision for the 8 channels, to generate output audio data including the audio data of 32-bit precision and the additional information for 8 channels, and output the output audio data to the video-audio synthesizing unit 130. The video-audio synthesizing unit 130 packetizes the output audio data for 8 channels of 3 samples into 6 channels, to generate four of the at least one audio sample packet. As shown in FIG. 9A, the packet type information indicating that the audio sample packet is of 32-bit precision is written in the header portion of each of the four audio sample packets.

Finally, the video-audio synthesizing unit 130 multiplexes the generated audio sample packets into the horizontal blanking interval of the video data (S105). For example, as shown in FIG. 9B, the video-audio synthesizing unit 130 multiplexes the four audio sample packets for every 32 clocks starting from the 59th clock of the horizontal blanking interval.

Furthermore, when the receiving apparatus 200 is not capable of processing the audio data of 32-bit precision (No in S102), the video-audio synthesizing unit 130 generates at least one audio sample packet including audio data of a conventional precision (24 bits, for example) (S106). The video-audio synthesizing unit 130 writes, into the header portion of the at least one audio sample packet, the packet type information (“0×02”, for example) indicating that the at least one audio sample packet includes the audio data having the conventional precision (S107).

Although it is not shown in FIG. 10, the video-audio data generated by multiplexing is converted into the differential analog signal by the TMDS transmission unit 140, and is transmitted to the receiving apparatus 200 via the TMDS signal line 310.

FIG. 11 shows a flowchart showing an example of the operation of the receiving apparatus 200 according to the embodiment of the present invention. Although it is not shown in FIG. 11, the differential analog signal received from the transmission apparatus 100 is converted into video-audio data by the TMDS receiving unit 240.

First, the video-audio demultiplexer unit 230 demultiplexes the video-audio data into the video data and the at least one audio sample packet (S201). Specifically, the video-audio demultiplexer unit 230 demultiplexes the video data and the at least one audio sample packet by reading the at least one audio sample packet from the horizontal blanking interval of the video-audio data.

Next, the video-audio demultiplexer unit 230 determines whether or not the audio data included in the at least one audio sample packet is of 32-bit precision (S202). Specifically, the video-audio demultiplexer unit 230 analyzes the header of the at least one audio sample packet to read the packet type information, and determines whether or not the read packet type information indicates that the at least one audio sample packet includes audio data of 32-bit precision.

When the audio data is of 32-bit precision (Yes in S202), the video-audio demultiplexer unit 230 restores, from the at least one audio sample packet, the input audio data including audio data of 32-bit precision and the additional information (S203). Then, the audio output unit 220 removes the additional information from the restored input audio data, to output the audio data of 32-bit precision (S205).

Furthermore, when the audio data is not of 32-bit precision (No in S202), the video-audio demultiplexer unit 230 restores from the at least one audio sample packet input audio data including audio data of the conventional bit precision (24-bit precision, for example) and the additional information (S204). Then, the audio output unit 220 removes the additional information from the restored input audio data, to output the audio data of the conventional bit precision (S205).

In the above manner, the transmission apparatus 100 according to the embodiment of the present invention packetizes the audio data of 32-bit precision to generate at least one audio sample packet, so that the generated at least one audio sample packet is multiplexed into the horizontal blanking interval of the video data. At this time, the transmission apparatus 100 writes, into the header portion of the at least one audio sample packet, new packet type information indicating that the at least one audio sample packet includes the audio data of 32-bit precision instead of that of conventional 24-bit precision.

Thus, with the transmission apparatus 100 according to the embodiment of the present invention, audio data of a higher precision can be transmitted without decreasing the bit precision of the audio data.

Furthermore, the transmission apparatus 100 obtains device information (EDID, for example) from the receiving apparatus 200, determines whether or not the obtained device information indicates that the receiving apparatus 200 is capable of processing the audio data of 32-bit precision, and, when the receiving apparatus 200 is capable of processing the audio data of 32-bit precision, generates the at least one audio sample packet including the audio data of 32-bit precision. When the receiving apparatus 200 is not capable of processing the audio data of 32-bit precision, but is capable of processing the audio data of conventional 24-bit precision, the transmission apparatus 100 generates at least one audio sample packet including the audio data of 24-bit precision in the same manner as in the conventional technique.

Thus, with the transmission apparatus 100 according to the embodiment of the present invention, the bit precision of the audio data to be included in the at least one audio sample packet can be determined depending on the processing capability of the receiving apparatus 200. Therefore, the audio data of a bit precision which the receiving apparatus 200 can accurately process can be transmitted to the receiving apparatus 200.

Furthermore, specifically, the transmission apparatus 100 packetizes the audio data of 32-bit precision for maximum of 6 channels and the additional information for each of the audio data from among the audio data of 32-bit precision for maximum of 8 channels and the additional information for each of the audio data, to generate the at least one audio sample packet having the same data size as the conventional audio sample packet. The transmission apparatus 100 then multiplexes the generated at least one audio sample packet using the horizontal blanking interval of the video data.

More specifically, the transmission apparatus 100 generates four of the at least one audio sample packet by packetizing the audio data of 32-bit precision for maximum of 8 channels of 3 samples.

The transmission apparatus 100 then multiplexes the generated at least one audio sample packet for every 32 pixel clocks stating from the 59th pixel clock of the horizontal blanking interval.

Thus, with the transmission apparatus 100 according to the embodiment of the present invention, other information can be transmitted using a first 58 pixel clocks interval of the horizontal blanking interval. Therefore, the at least one audio sample packet can be transmitted by effectively using the horizontal blanking interval remained.

Furthermore, the receiving apparatus 200 according to the embodiment of the present invention demultiplexes the at least one audio sample packet and the video data from the video-audio data, and determines the packet type information included in a header of the demultiplexed at least one audio sample packet, to determine whether or not the at least one audio sample packet include audio data of 32-bit precision. When the audio data of 32-bit precision is included, the receiving apparatus 200 restores from the at least one audio sample packet input audio data including audio data of 32-bit precision and the additional information.

Thus, with the receiving apparatus 200 according to the embodiment of the present invention, the audio data of a higher precision can be received without decreasing the bit precision of the audio data.

Furthermore, specifically, the receiving apparatus 200 restores the input audio data including the audio data of 32-bit precision for maximum of 8 channels and the additional information for each of the audio data, from the at least one audio sample packet generated by packetizing the audio data of 32-bit precision for maximum of 6 channels and the additional information for each of the audio data. More specifically, the receiving apparatus 200 restores from the four audio sample packets the audio data of 32-bit precision for maximum of 8 channels of 3 samples. Furthermore, the receiving apparatus 200 demultiplexes the video data and the audio data from the video-audio data, by reading the at least one audio sample packet for every 32 pixel clocks starting from the 59th pixel clock of the horizontal blanking interval.

Thus, with the receiving apparatus 200 according to the embodiment of the present invention, other information can be received using the first 58 pixel clocks interval of the horizontal blanking interval. Therefore, the at least one audio sample packet can be received by effectively using the horizontal blanking interval remained.

Although the transmission apparatus, the receiving apparatus, the transmission method, and the receiving method have been described based on the embodiment, the present invention is not limited to the embodiment. Other forms in which various modifications apparent to those skilled in the art are applied to the embodiment, or forms structured by combining constituent elements of different embodiments are included within the scope of the present invention, unless such changes and modifications depart from the scope of the present invention.

For example, although an example in which the audio data of 32-bit precision is multiplexed into the horizontal blanking interval of the video data has been described in the above embodiment, audio data of N-bit precision that is higher than 32-bit precision may be multiplexed into the horizontal blanking interval of the video data. Here, N is a natural number greater than 32 and smaller than 53. The following describes a case where N=52, as an example.

FIG. 12A shows an example of a format of audio sample packets according to a modification example of the embodiment of the present invention.

As shown in FIG. 12A, the video-audio synthesizing unit 130 writes into HB0 a new PacketTypeValue indicating that the data is of a new packet type. More specifically, the video-audio synthesizing unit 130 writes, for example, “0×0C” (“12” in decimal number) as the new HB0, instead of “0×02” (“2” in decimal number) written into the HB0 in the conventional technique. “0×0C” is an example of the new PacketTypeValue, and indicates that the data portion of the at least one audio sample packet includes audio data of 52-bit precision for 4 channels.

Furthermore, as shown in FIG. 12A, PB0 to PB13 include audio data of 52-bit precision for the first channel, audio data of 52-bit precision for the second channel, and additional data for the audio data for each of the first channel and the second channel. Specifically, PB0 to PB6 include data of 52 bits for the first channel (L.0 to L.51), and PB6 to PB12 include data of 52 bits for the second channel (R.0 to R.51). PB13 includes PL, CL, UL, and VL which are the additional information for the first channel, and PR, CR, UR, and VR which are the additional information for the second channel.

In the same manner, PB14 to PB27 include the audio data and the additional information for the third channel and the fourth channel.

The video-audio synthesizing unit 130 multiplexes the audio sample packets having the data for maximum of 4 channels as shown in FIG. 12A into the horizontal blanking interval (interval during the 280 pixel clocks) of the video data, as shown in FIG. 12B. FIG. 12B shows a timing chart which shows an example of output timing of the audio sample packets according to the modification example of the embodiment of the present invention.

It is to be noted that when the audio data of 52-bit precision for 8 channels is inputted, the video-audio synthesizing unit 130 can include into one audio sample packet the audio data of 52-bit precision for only 4 channels, as shown in FIG. 12A. Therefore, as shown in FIG. 12B, the video-audio synthesizing unit 130 packetizes the audio signals for 8 channels of 3 samples to generate six of the at least one audio sample packet.

In other words, the video-audio synthesizing unit 130 generates a first audio sample packet by packetizing the output audio data for the first channel through the fourth channel of a first sample (sample N), and a second audio sample packet by packetizing the output audio data for fifth channel through the eighth channel of the first sample. Furthermore, the video-audio synthesizing unit 130 generates a third audio sample packet by packetizing the output audio data for the first channel through the fourth channel of a second sample (sample N+1), and a fourth audio sample packet by packetizing the output audio data for the fifth channel through the eighth channel of the second sample. Furthermore, the video-audio synthesizing unit 130 generates a fifth audio sample packet by packetizing the output audio data for the first channel through the fourth channel of a third sample (sample N+2), and a sixth audio sample packet by packetizing the output audio data for the fifth channel through the eighth channel of the third sample.

It is to be noted that the audio sample packets shown in FIG. 12A can be multiplexed into the horizontal blanking interval of the video data by the allocation method shown in FIG. 8, in the same manner as in the case where the audio data is of 24-bit precision.

Furthermore, in the receiving apparatus 200 according to the modification example of the embodiment of the present invention, the video-audio demultiplexer unit 230 restores from the first audio sample packet the input audio data for the first channel through the fourth channel of the first sample (sample N), and restores from the second audio sample packet the input audio data for the fifth channel through the eighth channel of the first sample. Furthermore, the video-audio demultiplexer unit 230 restores from the third audio sample packet the input audio data for the first channel through the fourth channel of the second sample (sample N+1), and restores from the second audio sample packet the input audio data for the fifth channel through the eighth channel of the second sample. Furthermore, the video-audio demultiplexer unit 230 restores from the fifth audio sample packet the input audio data for the first channel through the fourth channel of the third sample (sample N+2), and restores from the sixth audio sample packet the input audio data for the fifth channel through the eighth channel of the third sample.

Thus, with the transmission apparatus and the receiving apparatus according to the modification example of the embodiment of the present invention, the audio data of higher than or equal to 32 bits can be transmitted and received.

Furthermore, in the above embodiment, as shown in FIG. 8, 9 lines out of 24 lines are used when multiplexing the at least one audio sample packet into the horizontal blanking interval of the video data. In other words, a plurality of audio sample packets may be multiplexed into a same interval by using the 15 data lines remained.

FIG. 13 shows an example of allocation of audio sample packets according to the modification example of the embodiment of the present invention. FIG. 13 shows an example in which two of the at least one audio sample packet are multiplexed into a same interval.

As shown in FIG. 13, the video-audio synthesizing unit 130 outputs the first audio sample packet using T_VD[2], T_VD[8] to T_VD[11], and T_VD[16] to T_VD[19], and outputs the second audio sample packet using T_VD[3], T_VD[12] to T_VD[15], and T_VD[20] to T_VD[23]. It is to be noted that the data line used for outputting the audio sample packet is not limited to this example.

Furthermore, the video-audio synthesizing unit 130 may output the at least one audio sample packet with regarding a clock other than the 59th clock of the horizontal blanking interval as a first clock. Furthermore, a blank interval may be set between a packet and a packet instead of outputting a plurality of audio sample packets in series, or other data may be transmitted.

Furthermore, although a configuration in which the audio data of 3 samples are multiplexed in the horizontal blanking interval has been described, audio data of greater than or equal to 4 samples may be multiplexed.

Furthermore, the transmission apparatus 100 according to the embodiment of the present invention may obtain the audio data of 24-bit precision and generate an input audio signal of 32-bit precision by performing an arithmetic operation for increasing the sound quality on the obtained audio signal of 24-bit precision. Then, the audio input unit 120 may obtain the generated input audio signal of 32 bits.

Furthermore, the transmission apparatus and the receiving apparatus according to the present invention do not necessary comply with the HDMI standard. In other words, the transmission apparatus according to the present invention can, when transmitting video data and if there is a horizontal blanking interval of the video data, transmit the audio data using the horizontal blanking interval in the above manner. For example, the transmission apparatus and the receiving apparatus according to the present invention may comply with a DisplayPort standard.

Furthermore, the present invention may be achieved as a program for causing a computer to execute a transmission method and a receiving method of the present embodiment, in addition to be achieved as the transmission apparatus, the receiving apparatus, the transmission method, and the receiving method as described above. Furthermore, the present invention may be achieved as a computer-readable recording medium for use in a computer, such as a CD-ROM, having the computer program recorded thereon. Moreover, the present invention may be achieved as information, data, or signals indicating the program. These program, information, data, and signals may be distributed via a communication network such as the Internet.

Furthermore, a part or all of the constituent elements constituting the transmission apparatus and the receiving apparatus may be configured from a single System-LSI (Large-Scale Integration). The System-LSI is a super-multi-function LSI manufactured by integrating constituent elements on one chip, and is specifically a computer system configured by including a microprocessor, a ROM, a RAM, and so forth.

For example, an integrated circuit including the transmission function according to the present invention includes a transmission control unit 110, an audio input unit 120, a video-audio synthesizing unit 130, and a TMDS transmission unit 140, which are shown in FIG. 1. Furthermore, an integrated circuit including the receiving function according to the present invention includes a receiving control unit 210, an audio output unit 220, a video-audio demultiplexer unit 230, and a TMDS receiving unit 240, which are shown in FIG. 1.

Furthermore, the present invention may be achieved as a video-audio synthesizing apparatus including an audio input unit 120 and a video-audio synthesizing unit 130, or a video-audio synthesizing method including processing executed by a processing unit of the video-audio synthesizing apparatus. Alternatively, the present invention may be achieved as a video-audio demultiplexer apparatus including an audio output unit 220 and a video-audio demultiplexer unit 230, or a video-audio demultiplexing method including processing executed by a processing unit of the video-audio demultiplexer apparatus.

Furthermore, all of the numerals in the above are used for exemplification purpose for describing the present invention more specifically, and the present invention is not limited to the numerals exemplified. Furthermore, the connection relationship between the constituent elements are described for specifically describing the present invention, and the connection relationship for achieving the function of the present invention is not limited to the above.

Moreover, although the above embodiment is configured with hardware and/or software, the configuration using hardware can also be configured using software, and the configuration using software can also be configured using hardware.

Although only some exemplary embodiments of the present invention have been described in detail above, those skilled in the art will readily appreciate that many modifications are possible in the exemplary embodiments without materially departing from the novel teachings and advantages of the present invention. Accordingly, all such modifications are intended to be included within the scope of the present invention.

### INDUSTRIAL APPLICABILITY

The transmission apparatus and the receiving apparatus according to the present invention can be used for electrical appliances such as a digital TV and a digital video recorder complying with, for example, the HDMI standard or the DisplayPort standard.

1. A transmission apparatus which transmits to a receiving apparatus video-audio data generated by multiplexing audio data into a horizontal blanking interval of video data, the transmission apparatus comprising:
an audio input unit configured to obtain first audio data of 32-bit precision and to add additional information to the first audio data, to generate first output audio data including the first audio data and the additional information, the additional information indicating characteristics of the first audio data obtained; and
a synthesizing unit configured to: add packet type information to the first output audio data generated by the audio input unit, to generate at least one audio sample packet; and multiplex the at least one audio sample packet into the horizontal blanking interval of the video data, the packet type information indicating that the first output audio data includes audio data of 32-bit precision.

2. The transmission apparatus according to claim 1, further comprising
a control unit configured to obtain device information indicating whether or not the receiving apparatus is capable of processing audio data of 32-bit precision,
wherein the audio input unit is configured to generate the first output audio data when the device information obtained by the control unit indicates that the receiving apparatus is capable of processing the audio data of 32-bit precision.

3. The transmission apparatus according to claim 2,
wherein the transmission apparatus communicates with the receiving apparatus according to a high-definition multimedia interface (HDMI) standard, and
the control unit is configured to obtain extended display identification data (EDID) as the device information from the receiving apparatus via a display data channel (DDC) signal line.

4. The transmission apparatus according to claim 1,
wherein the audio input unit is configured to obtain the first audio data for n channel and to add the additional information to a corresponding first audio data, to generate the first output audio data for n channel, n being between 1 and 8 inclusive, and the additional information indicating characteristics of the first audio data obtained, and
the synthesizing unit is configured to: packetize the first output audio data for n channel into the first output audio data for m channel to generate the at least one audio sample packet; and
multiplex the at least one audio sample packet into the horizontal blanking interval of the video data, m being between 1 and 6 inclusive.

5. The transmission apparatus according to claim 4,
wherein the synthesizing unit is configured to multiplex the at least one audio sample packet for every 32 clocks starting from a 59th clock in a pixel clock cycle of the horizontal blanking interval of the video data.

6. The transmission apparatus according to claim 4,
wherein n=8 and m=6, and
the synthesizing unit is configured to generate four of the at least one audio sample packet from the first output audio data for 8 channels of three samples.

7. The transmission apparatus according to claim 6,
wherein the first output audio data for the 8 channels of the three samples is the first output audio data for a first channel, a second channel, a third channel, a fourth channel, a fifth channel, a sixth channel, a seventh channel, and an eighth channel, of a first sample, a second sample, and a third sample,
the four audio sample packets are a first audio sample packet, a second audio sample packet, a third audio sample packet, and a fourth audio sample packet, and
the synthesizing unit is configured to: generate the first audio sample packet by packetizing the first output audio data for the first channel through the sixth channel of the first sample; generate the second audio sample packet by packetizing the first output audio data for the seventh channel and the eighth channel of the first sample and for the first channel through the fourth channel of the second sample; generate the third audio sample packet by packetizing the first output audio data for the fifth channel through the eighth channel of the second sample and for the first channel and the second channel of the third sample; and generate the fourth audio sample packet by packetizing the first output audio data for the third channel through the eighth channel of the third sample.

8. The transmission apparatus according to claim 2,
wherein, when the device information obtained by the control unit indicates that the receiving apparatus is capable of processing audio data of 24-bit precision,
(i) the audio input unit is configured to: remove a part of the obtained first audio data, to generate second audio data of 24-bit precision; and add additional information to the second audio data, to generate second output audio data including the second audio data and the additional information, the additional information indicating characteristics of the second audio data generated, and
(ii) the synthesizing unit is configured to: packetize the second output audio data to generate at least one audio sample packet; and multiplex the at least one audio sample packet into the horizontal blanking interval of the video data, the second output audio data being generated by the audio input unit.

9. A transmission apparatus which transmits to a receiving apparatus video-audio data generated by multiplexing audio data into a horizontal blanking interval of video data, the transmission apparatus comprising:
an audio input unit configured to obtain the audio data of N-bit precision and add additional information to the audio data, to generate output audio data including the audio data of N-bit precision and the additional information, N being a natural number satisfying 32<N<53, and the additional information indicating characteristics of the audio data obtained; and
a synthesizing unit configured to: add packet type information to the output audio data generated by the audio input unit, to generate at least one audio sample packet; and multiplex the at least one audio sample packet into the horizontal blanking interval of the video data, the packet type information indicating that the output audio data includes audio data of N-bit precision.

10. A receiving apparatus which receives from a transmission apparatus video-audio data generated by multiplexing at least one audio sample packet generated by packetizing audio data into a horizontal blanking interval of video data, the receiving apparatus comprising:
a demultiplexer unit configured to: demultiplex from the video-audio data the at least one audio sample packet and the video data; and restore, from the demultiplexed at least one audio sample packet, first input audio data including first audio data of 32-bit precision and additional information indicating characteristics of the first audio data; and
an audio output unit configured to remove the additional information from the first input audio data restored by the demultiplexer unit, to output the first audio data,
wherein the demultiplexer unit is configured to: read packet type information included in a header of the demultiplexed at least one audio sample packet; and restore the first input audio data when the read packet type information indicates that the at least one audio sample packet includes audio data of 32-bit precision.

11. The receiving apparatus according to claim 10,
wherein the demultiplexer unit is configured to: demultiplex from the video-audio data the at least one audio sample packet and the video data; and restore, from the demultiplexed at least one audio sample packet, the first input audio data for n channel, the at least one audio sample packet being generated by packetizing the first audio data for m channel, m being between 1 and 6 inclusive, and n being between 1 and 8 inclusive, and
the audio output unit is configured to remove the additional information from the first input audio data for n channel to output the first audio data for n channel.

12. The receiving apparatus according to claim 11,
wherein the demultiplexer unit is configured to read the at least one audio sample packet for every 32 clocks starting from a 59th clock in a pixel clock cycle of the horizontal blanking interval of the video-audio data, to demultiplex the video data and the at least one audio sample packet.

13. The receiving apparatus according to claim 11,
wherein n=8 and m=6, and
the demultiplexer unit is configured to: demultiplex from the video-audio data four of the at least one audio sample packet and the video data; and restore from the four audio sample packets the first input audio data for 8 channels of 3 samples.

14. The receiving apparatus according to claim 13,
wherein the four audio sample packets are a first audio sample packet, a second audio sample packet, a third audio sample packet, and a fourth audio sample packet,
the first input audio data for the 8 channels of the three samples are the first input audio data for a first channel, a second channel, a third channel, a fourth channel, a fifth channel, a sixth channel, a seventh channel, and an eighth channel, of a first sample, a second sample, and a third sample, and
the demultiplexer unit is configured to: restore from the first audio sample packet the first input audio data for the first channel through the sixth channel of the first sample; restore from the second audio sample packet the first input audio data for the seventh channel and the eighth channel of the first sample and for the first channel through the fourth channel of the second sample; restore from the third audio sample packet the first input audio data for the fifth channel through the eighth channel of the second sample and for the first channel and the second channel of the third sample; and
restore from the fourth audio sample packet the first input audio data for the third channel through the eighth channel of the third sample.

15. The receiving apparatus according to claim 10,
wherein, when the packet type information indicates that the at least one audio sample packet includes audio data of 24-bit precision,
(i) the demultiplexer unit is configured to: demultiplex the at least one audio sample packet and the video data; and restore, from the demultiplexed at least one audio sample packet, second input audio data including second audio data of 24-bit precision and additional information indicating characteristics of the second audio data; and
(ii) the audio output unit is configured to remove the additional information from the second input audio data restored by the demultiplexer unit, to output the second audio data.

16. A receiving apparatus which receives from a transmission apparatus video-audio data generated by multiplexing at least one audio sample packet into a horizontal blanking interval of video data, the at least one audio sample packet being generated by packetizing audio data, the receiving apparatus comprising:
a demultiplexer unit configured to: demultiplex from the video-audio data the at least one audio sample packet and the video data; and restore, from the demultiplexed at least one audio sample packet, input audio data including audio data of N-bit precision and additional information indicating characteristics of the audio data, N being a natural number satisfying 32<N<53; and
an audio output unit configured to remove the additional information from the input audio data restored by the demultiplexer unit, to output the audio data of N-bit precision,
wherein the demultiplexer unit is configured to read packet type information included in a header of the demultiplexed at least one audio sample packet, and to restore the input audio data when the read packet type information indicates that the at least one audio sample packet includes audio data of N-bit precision.

17. A transmission method of transmitting to a receiving apparatus video-audio data generated by multiplexing audio data into a horizontal blanking interval of video data, the transmission method comprising:
obtaining device information from the receiving apparatus, and determining whether or not the obtained device information indicates that the receiving apparatus is capable of processing audio data of 32-bit precision;
obtaining first audio data of 32-bit precision, and when it is determined that the receiving apparatus is capable of processing audio data of 32-bit precision in the determining, adding additional information to the first audio data, to generate first output audio data including the first audio data and the additional information, the additional information indicating characteristics of the first audio data; and
adding packet type information to the first output audio data generated in the adding, to generate at least one audio sample packet, and multiplexing the at least one audio sample packet into the horizontal blanking interval of the video data, the packet type information indicating that the first output audio data includes audio data of 32-bit precision.

18. A receiving method of receiving from a transmission apparatus video-audio data generated by multiplexing at least one audio sample packet generated by packetizing audio data into a horizontal blanking interval of video data, the receiving method comprising:
demultiplexing from the video-audio data the at least one audio sample packet and the video data and restoring, from the demultiplexed at least one audio sample packet, first input audio data including first audio data of 32-bit precision and additional information indicating characteristics of the first audio data; and
removing the additional information from the first input audio data restored in the demultiplexing, to output the first audio data,
wherein in the demultiplexing, reading packet type information included in a header of the demultiplexed at least one audio sample packet and restoring the first input audio data when the read packet type information indicates that the at least one audio sample packet includes audio data of 32-bit precision.

19. An integrated circuit which transmits to a receiving apparatus video-audio data generated by multiplexing audio data into a horizontal blanking interval of video data, the integrated circuit comprising:
an audio input unit configured to obtain first audio data of 32-bit precision and to add additional information to the first audio data, to generate first output audio data including the first audio data and the additional information, the additional information indicating characteristics of the first audio data obtained; and
a synthesizing unit configured to: add packet type information to the first output audio data generated by the audio input unit, to generate at least one audio sample packet; and multiplex the at least one audio sample packet into the horizontal blanking interval of the video data, the packet type information indicating that the first output audio data includes audio data of 32-bit precision.

20. An integrated circuit which receives from a transmission apparatus video-audio data generated by multiplexing at least one audio sample packet generated by packetizing audio data into a horizontal blanking interval of video data, the integrated circuit comprising:
a demultiplexer unit configured to: demultiplex from the video-audio data the at least one audio sample packet and the video data; and restore, from the demultiplexed at least one audio sample packet, first input audio data including first audio data of 32-bit precision and additional information indicating characteristics of the first audio data; and
an audio output unit configured to remove the additional information from the first input audio data restored by the demultiplexer unit, to output the first audio data,
wherein the demultiplexer unit is configured to: read packet type information included in a header of the demultiplexed at least one audio sample packet; and restore the first input audio data when the read packet type information indicates that the at least one audio sample packet includes audio data of 32-bit precision.
